(19) United States
(12) Patent Application Publication
(10) Pub. No.: US 2021/0218005 A1
(43) Pub. Date: Jul. 15, 2021

(54) PROTECTED LITHIUM COATINGS ON SEPARATORS FOR LITHIUM ION BATTERIES

(71) Applicant: Storedot Ltd., Herzeliya (IL)

(72) Inventors: Eynat MATZNER, Adi (IL); Daniel ARONOV, Netanya (IL)

(73) Assignee: Storedot Ltd., Herzeliya (IL)

(21) Appl. No.: 16/737,978

(22) Filed: Jan. 9, 2020

(51) Int. Cl. H01M 2/16; H01M 10/0525; H01M 4/04

(52) U.S. Cl. CPC H01M 2/1673; H01M 4/0409; H01M 10/0525; H01M 2/166

(57) ABSTRACT

Lithium ion batteries, cell stacks, separators and methods of producing thereof are provided. Separators comprise lithium coating on at least a part of a separator sheet, possibly with a protective layer made of a soluble polymer that covers the lithium coating from one or both sides of the separator sheet. Cell stacks are assembled with disclosed separators, in ways that may physically attach the lithium coating to the electrodes (anode(s) and/or cathode(s)) to prelithiate or lithiate them, respectively; and/or electrochemical processes may be used to deliver lithium from the coating to the respective electrodes. Disclosed methods increase the energy capacity and the stability of the formed lithium ion batteries, yielding energy-dense, long-living and fast charging batteries.

### BACKGROUND OF THE INVENTION

### 1. Technical Field

The present invention relates to the field of energy storage, and more particularly, to lithium ion batteries.

### 2. Discussion of Related Art

Holtstiege et al. 2018 (Pre-lithiation strategies for rechargeable energy storage technologies: concepts, promises and challenges, Batteries 4, 4) review various ways to pre-lithiate lithium ion batteries.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a separator for a lithium ion battery, the separator comprising: a separator sheet, a lithium coating on at least part of the separator sheet, and a protective layer covering the lithium coating, the protective layer made of a soluble polymer.

One aspect of the present invention provides a cell stack for a lithium ion battery, the cell stack comprising: at least one anode, at least one cathode, and at least one separator comprising a separator sheet and a lithium coating on at least part of the separator sheet; wherein the at least one anode, the at least one cathode, and the at least one separator are assembled to form the cell stack.

One aspect of the present invention provides a method comprising lithiating at least one electrode of a lithium ion battery, by: coating lithium on at least part of a separator sheet, on a side facing the at least one electrode that is to be lithiated, and attaching the separator sheet to the at least one electrode.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1A is a high-level schematic illustration of a lithium ion battery, according to some embodiments of the invention.

FIGS. 1B-1J are high level schematic illustrations of separators, according to various embodiments of the invention.

FIGS. 2A and 2B are high level schematic illustrations of press roll assembly, according to various embodiments of the invention.

FIG. 2C is a high-level schematic illustration of attaching a lithium foil to a separator sheet to ford a separator, according to various embodiments of the invention.

FIGS. 3A and 3B are high level schematic illustrations of round and prismatic winding assembly, respectively, according to various embodiments of the invention.

FIG. 4 is a high-level schematic illustration of single sheet stacking assembly, according to various embodiments of the invention.

FIGS. 5A and 5B are high level schematic illustrations of Z-folding assembly, respectively, according to various embodiments of the invention.

FIG. 6 is a high-level flowchart illustrating a method, according to some embodiments of the invention.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Embodiments of the present invention provide efficient and economical methods and mechanism for increasing the energy density and the stability of components of lithium ion batteries and thereby provide improvements to the technological field of energy storage. Lithium ion batteries, cell stacks, separators and methods of producing thereof are provided. Separators comprise lithium coating on at least a part of a separator sheet, possibly with a protective layer made of a soluble polymer that covers the lithium coating from one or both sides of the separator sheet. Cell stacks are assembled with disclosed separators, in ways that may physically attach the lithium coating to the electrodes (anode(s) and/or cathode(s)) to prelithiate or lithiate them, respectively; and/or electrochemical processes may be used to deliver lithium from the coating to the respective electrodes. Disclosed methods increase the energy capacity and the stability of the formed lithium ion batteries, yielding energy-dense, long-living and fast charging batteries.

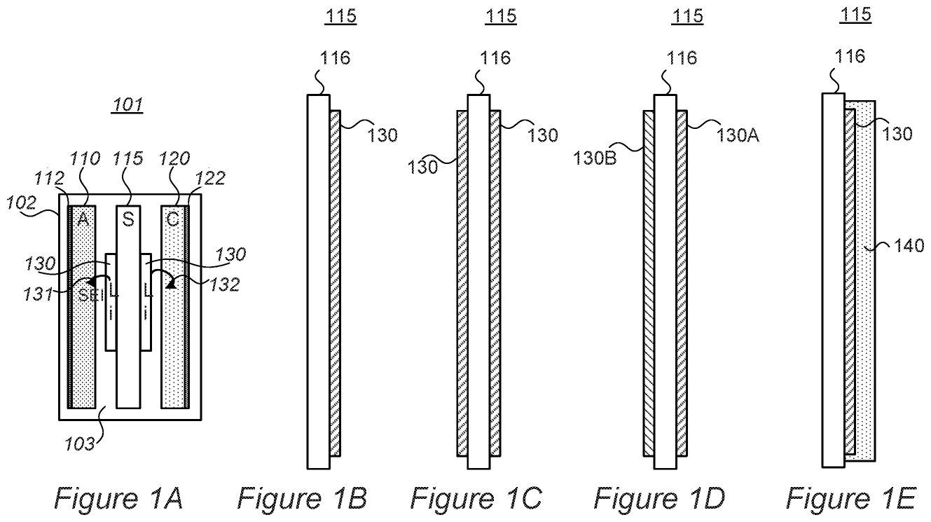

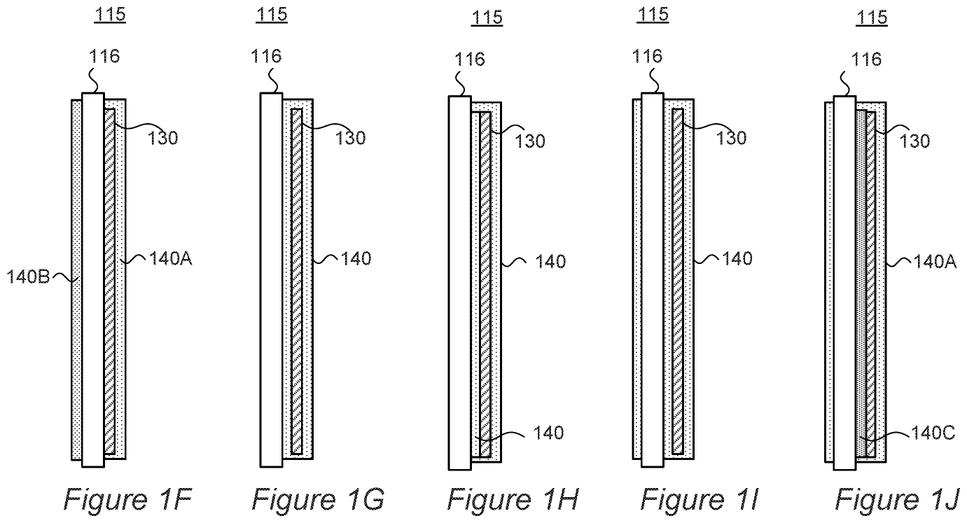

FIG. 1A is a high-level schematic illustration of a lithium ion battery 101, according to some embodiments of the invention. Lithium ion batteries 101 comprise anode(s) 110 (with current collector(s) 112), separator(s) 115 and cathode(s) 120 (with current collector(s) 122), packaged with an electrolyte 103 in a pouch cover 102. It is noted that the figure is very schematic, and merely relates to the ordering of some of the elements of the battery, without reflecting realistic spatial relations, for the sake of clarity of explanation. It is further noted that FIG. 1A does not illustrate, for simplicity reasons, the fact that electrolyte 103 contacts anodes 110 and cathodes 120 in separate compartments, delimited by separator 115. FIG. 1 illustrates schematically a lithium source 130 attached to separator 115 and used to form a SEI (solid electrolyte interphase) on anode(s) 110 (131) and/or to lithiate cathode(s) 120 (132). SEI formation typically occurs during a formation stage of battery 101, in which it is prepared to operation at a production facility. Cathode lithiation may be carried out during the formation stage, and/or controllably during the operation of battery 101 by a used. For example, cathode lithiation may be applied upon monitoring of the state of health (SoH) of battery 101 by a battery management system (BMS, not shown) to supplant the cathodes with lithium when lithium level decreases are detected.

FIGS. 1B-1J are high level schematic illustrations of separators 115, according to various embodiments of the invention. Separator 115 may comprise a separator sheet 116, a lithium coating 130 (as lithium source 130) on at least part of separator sheet 116, and a protective layer 140 covering lithium coating 130. For example, protective layer 140 may be made of a soluble polymer such as any of poly(methyl methacrylate) (PMMA), low molecular weight butyl acrylate (soft and rubbery material), PEG (polyethylene glycol) waxes, poly-VC (poly-(vinylene carbonate)), PVP (Poly vinyl pyrrolidone). Protective layer 140 may be configured to prevent contact of water and/or of oxygen with lithium coating 130 during assembly of lithium ion battery 101, and at least partly dissolve in electrolyte 103 thereof once assembled in a battery pouch or other enclosure.

In various embodiments, lithium coating 130 may be on one side of separator sheet 116 as illustrated schematically in FIGS. 1B and 1E-1J, or on both sides of separator sheet 116, as illustrated schematically in FIGS. 1C, with same lithium coating 130 on both sides as in FIG. 1D, or with different lithium coatings 130A, 130B on either side as in FIG. 1D. Lithium coatings 130A, 130B may differ, e.g., in the thickness of the coating, in the load of lithium in the coating etc.

In various embodiments, protective layer 140 may be on one side of separator sheet 116 as illustrated schematically in FIGS. 1E, 1G and 1H, or on both sides of separator sheet 116, as illustrated schematically in FIGS. 1F, 1I and 1J with same protective layer 140 on both sides as in FIG. 1I or with different protective layer 140A, 140B on either side as in FIG. 1F and/or with two or more protective materials 140A, 140C configured to provide different types of protection and dissolution on the sheet-facing side and on the electrolyte-facing side of separator sheet 116, respectively. Protective layer 140A, 140B, 140C may differ from each other in the types of materials, layer thickness and density, degree of solubility, etc.

Various embodiments include any of the combinations of lithium coatings 130 and protective layers 140 illustrated in FIGS. 1B-1J, specifically the illustration of certain features in one of the figures does not limit its applicability to any of the embodiments illustrated in the other figures. Elements from FIGS. 1B-1J may be combined in any operable combination, and the illustration of certain elements in certain figures and not in others merely serves an explanatory purpose and is non-limiting. In any of the embodiments, lithium coatings 130 may comprise any of: a continuous lithium coating, patches or islands of lithium within the area of lithium coating 130, a pattern including lithium containing regions and regions devoid of lithium, any of the previous with any of: metallic lithium, lithium compounds (e.g., salts), lithium polymers (e.g., organic polymers with bonded or associated lithium ions) etc.

For example, when providing anode prelithiation 131 only or when providing cathode lithiation 132 only, lithium coating 130 and protective layer 140 may be formed on the side of separator sheet 116 which faces the respective electrode (anode 110 and cathode 120, respectively). In certain embodiments, lithium coating 130 may be formed on one side of separator sheet 116 and protective layer 140 may be on one or both sides of separator sheet 116, as illustrated schematically e.g., in FIGS. 1E, 1G, 1H and 1F, 1I, 1J, respectively. The at least partial dissolution of protective layer 140 may expose lithium coating 130 and allow lithium ions to move to the respective electrode that is to be lithiated.

In certain embodiments, protective layer 140 may be formed on one side of separator 115 (see, e.g., FIG. 1E, 1G, 1H), or on both sides of separator sheet 116 (e.g., FIGS. 1F, 1I, 1J), and two or more protective materials 140A, 140B, 140C may be used to provide different types of protection and dissolution on the sheet-facing side and on either side of the electrolyte-facing side of separator sheet 116. For example, protective layer 140C may be configured to prevent interaction between lithium coating 130 and separator sheet 116, protective layer 140B may be configured to prevent interaction between lithium coating 130 and the electrolyte through separator sheet 116, and/or protective layer 140A may be configured to prevent interaction between lithium coating 130 and external fluid or air. The dissolution rates of protective layers 140A, 140B, 140C may also differ, determining the amount of the lithium exposed to the respective electrodes on each side of separator 115 and the duration of the lithium exposure to each of the electrodes. Moreover, protective layer 140 may also be configured to control the direction of lithium movement from lithium coating 130. For example, protective layer 140 may be configured to enable lithium movement in one direction only, e.g., referring to FIG. 1J, if external protective layer 140A is configured to dissolve before internal protective layer 140C dissolves, lithium from lithium coating 130 may preferentially diffuse to the exposed side and corresponding electrode on the respective side of separator 115.

Lithium coating 130 may be applied onto separator sheet 116 and/or on a sheet that may be attached to separator sheet 116 (see below) using various techniques, such as physical vapor deposition (PVD), chemical vapor deposition (CVD), thermal spraying, vacuum coating, and/or liquid-based deposition (e.g., dip coating or electrodeposition). In PVD, a lithium source may be vaporized to form gaseous atoms, molecules or partially ionized ions under a vacuum condition, which are deposited to form a (possibly patterned) film on the surface of the substrate by a low-pressure gas (or plasma). The main methods of PVD include vacuum evaporation, sputtering and ion plating. PVD may be used to deposit lithium and/or lithium compounds on compounds, ceramics, semiconductors, polymer films, etc. In CVD, a thin, possibly patterned, lithium film may be deposited by chemical reaction(s) on the surface of a substrate using one or several gas phase compounds or simple substances. CVD may be used to deposit various single crystal, polycrystalline or glassy inorganic thin film materials. that contain lithium. Non-limiting examples for lithium application techniques include any of sputtering such as magnetron sputtering (MS), pulsed laser deposition (PLD), atomic layer deposition (ALD), vacuum evaporation, ion beam sputtering, plasma enhanced chemical vapor deposition (PECVD), reduced pressure CVD (RPCVD), metal-organic CVD (MOCVD), low-pressure CVD (LPCVD), plasma-assisted metal-organic CVD (PAMOCVD), ultra-high vacuum CVD (UHVCVD), laser-assisted CVD (LACVD), very low-pressure CVD (VLPCVD), rapid thermal low pressure (RTLPCVD), electron cyclotron resonance CVD (DECRCVD), etc.

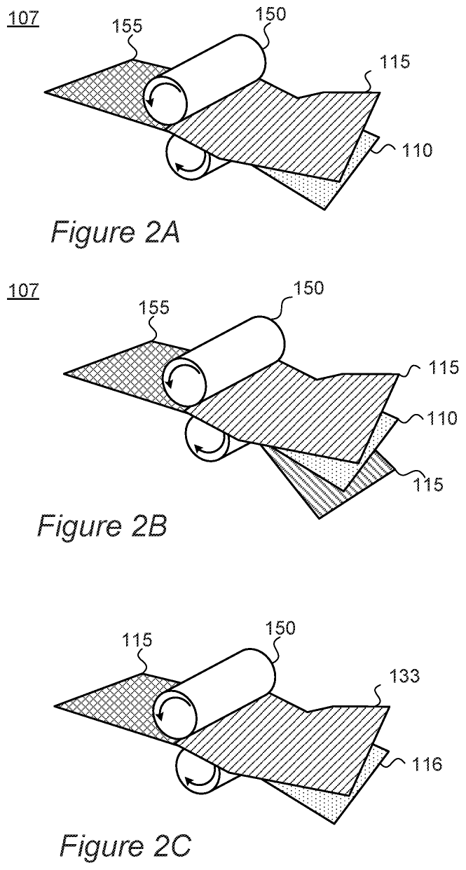

In various embodiments, lithium coating 130 may be applied as a sheet 133 (see FIG. 2C below) that may be attached to separator sheet 116, e.g., by calendaring (e.g., using pressing such as roll pressing) lithium foil 133 as lithium source 130 and/or in addition to deposited lithium coating 130—onto separator sheet 115. Protective layer 140 may also be at least partly calendared onto lithium foil 133 as lithium source 130 or may be applied by a different process. In certain embodiments, lithium foil 133 may be coated on one or both sides by protective layer 140 and then calendared onto separator sheet 115 to yield separator 116. Any of the configurations illustrated in FIG. 1B-1J may be produced by various coating and calendaring methods. For example, to yield one sided lithium coating 130 with two types of protective coatings 140A, 140C (a one sided implementation of FIG. 1J, or, equivalently, a two-polymer types implementation of FIG. 1H), separator sheet 116, polymer coating 140C, lithium foil 130 and polymer coating 140A may be pressed and/or calendared together to yield separator 115 that may be used in the cell assembly.

For example, lithium coating 130 may comprise layers 1-20μm or 5-15μm thick, on one or both sides of separator sheet 116. Lithium coating 130 may be applied on metal foils and/or polymer sheets, either as separator sheet 116 or as sheets or foils that are attached to separator sheet 116.

Separator 115 may be configured to be mechanically robust and yield a workable lithium metal film, using self-supporting separator sheets 116 made of mechanically robust polymeric films. Disclosed lithium-coated separators 115 may be designed to be in the correct thickness to meet the quantitative amount of lithium required for the electrodes and be compatible with the cell stack and battery assembly systems and processes. As disclosed above, lithium coating 130 may be continuous or discontinuous/patterned and comprise metallic lithium and/or various lithium compounds (e.g., salts or polymers).

Certain embodiments comprise a cell stack 105 for lithium ion battery 101. Cell stacks 105 comprise at least one anode 110, at least one cathode 120, and at least one separator 115 comprising separator sheet 116 and lithium coating 130 on at least part of separator sheet 116. Anode(s) 110, cathode(s) 120, and separator(s) 115 are assembled to form cell stack 105.

Various assembly technologies may be used in assembly systems 107 to assemble cell stack 105, as provided in non-limiting examples in FIGS. 2A, 2B, 2C, 3A, 3B, 4, 5A and 5B. For example, assembly systems 107 and methods may include any of: a roll to roll process, a single sheet stacking, a winding process and/or a folding process. During assembly, lithium coating 130 may be pressed against anode(s) 110 to yield prelithiated anodes.

In certain embodiments, as described below, anode(s) 110 and/or cathode(s) 120 may be prelithiatedilithiated (respectively) before or at the beginning of the cell assembly process, e.g., by attaching separator 115 to respective anode(s) 110 and/or cathode(s) 120—and associate thereby at least part of lithium coating 130 with respective anode(s) 110 and/or cathode(s) 120. Possibly, different electrolytes may then be used for the prelithiation/lithiation stage, for formation stage and/or for consecutive battery operation. Accordingly, certain embodiments implement “out of cell” prelithiation of anode(s) 110 and/or lithiation of cathodes, before or during the assembly of the cell stack and not only upon formation of the battery. For example, lithium-coated separator 115 may be used to lithiate anode(s) 110 before cell assembly by pressing or attaching the lithium-coated side of separator 115 that faces anode 110 to anode 110, e.g., using a roll to roll process to press the layers together, e.g., in the presence of a temporary electrolyte (that may be replaced later by electrolyte used for cell operation). The process may be timed and controlled so that the lithiation is completed before the assembly of the cell and the operational electrolyte may be filled after cell assembly, e.g., upon enclosure of the stack in the pouch and/or following a formation stage. This process may include a rinsing bath for anode(s) 110 and separator(s) 115 before assembly, to remove residues of the temporary electrolyte used for pre-lithiation. With separators 115 having protective layer 140 upon lithium coating 130, protective layer 140 may be soluble in the temporary electrolyte, and its residues may be removed upon rinsing the temporary electrolyte. In certain embodiments, protective layer 140 or parts thereof (e.g., 140A, 140B, 140C etc.) may be not soluble in the operational electrolyte.

FIGS. 2A and 2B are high level schematic illustrations of press roll assembly 107, according to various embodiments of the invention. FIGS. 2A and 2B illustrate schematically one of press roll(s) 150, pressing lithium-coated separator(s) 115 onto anode(s) 110 to yield prelithiated anode attached to separator, denoted by numeral 155. FIGS. 2A and 2B illustrate schematically one- and two-sided prelithiation and attachment 155, respectively. Disclosed roll to roll processes may be performed on single- or double-sided anode (FIGS. 2A and 2B, respectively) with or without emersion in the solvent. In addition, cathode 120 (not shown) may also be roll-pressed in the same path, resulting in full stack 105 produced by press roll 150, yielding stack 105 of one or more sets of prelithiated anode with separator and cathode as single sided electrodes and/or separator with prelithiated anode, another separator and cathode for double sided electrodes.

FIG. 2C is a high-level schematic illustration of attaching lithium foil 133 to separator sheet 116 to form separator 115, according to various embodiments of the invention. The attachment may be carried out by press roll assembly 107 or by another, preparatory system. Lithium foil 133 may be prepared by any of the techniques disclosed above and then attached, e.g., calendared, onto separator sheet 116 to form separator 115.

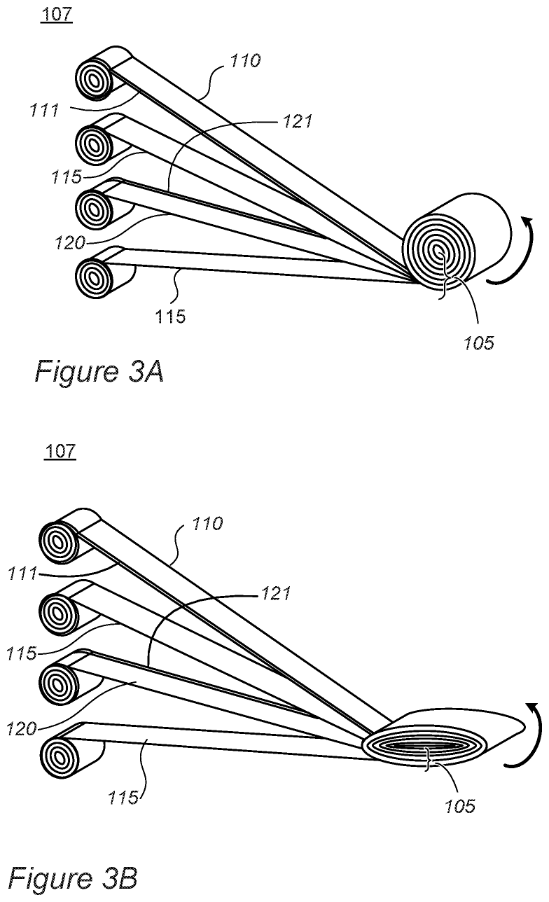

FIGS. 3A and 3B are high level schematic illustrations of round and prismatic winding assembly 107, respectively, according to various embodiments of the invention. FIGS. 3A and 3B illustrate schematically continuous anode(s) 110, separators) 115 and cathode(s) 120, possibly forming multiple sets thereof in stack 105, that are rolled and stacked together onto one or more spools. As disclosed above, prelithiation and/or lithiation may be carried out on one or two sides of the respective electrode (e.g., anode(s) 110, cathode(s) 120 or both). In certain embodiments, separator 115 may be pressed upon the respective electrode before or during the rolling process, to provide the disclosed prelithiation and/or lithiation of the respective electrode.

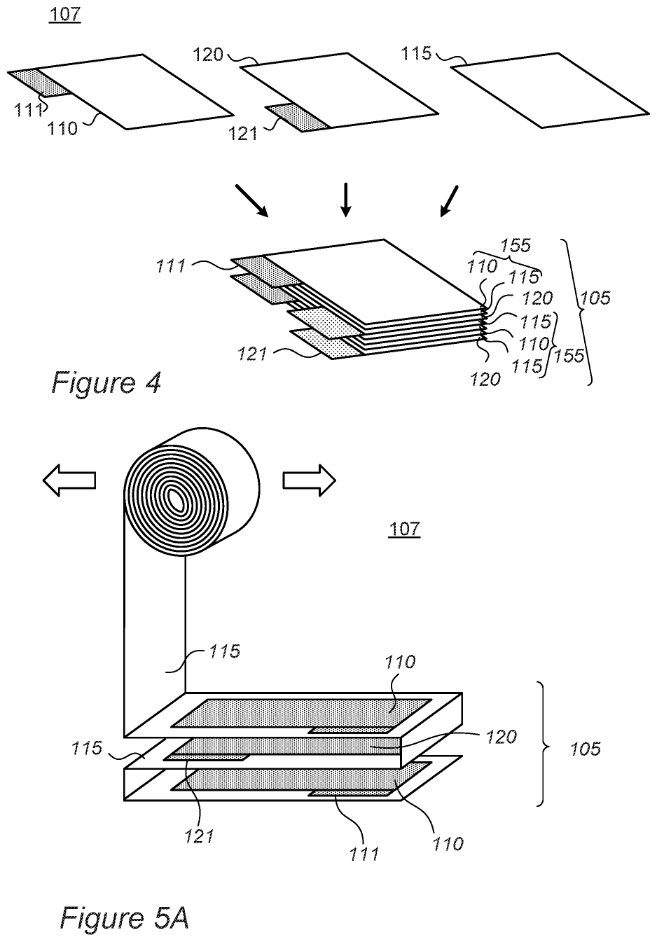

FIG. 4 is a high-level schematic illustration of single sheet stacking assembly 107, according to various embodiments of the invention. Multiple anode(s) 110, separator(s) 115 and cathode(s) 120 may be stacked alternatingly, with lithium-coated separator(s) 115 having the corresponding orientation (e.g., with the lithium coating facing the anodes when anode prelithiation is intended; with the lithium coating facing the cathodes when cathode lithiation is intended; or both). In certain embodiments, anode and separator sheets may be pressed together before they are further stacked, as prelithiated anode attached to separator (155), with cathode(s) 120, to form cell stack 105. Two options for anode-separator attachment 155 are illustrated schematically, namely one-sided and two-sided attachment, which may be used together in forming cell stack 105 (e.g., the formal for the external layers and the latter for the internal layers in the stack), or one type of attachment 155 may be used throughout stack 105.

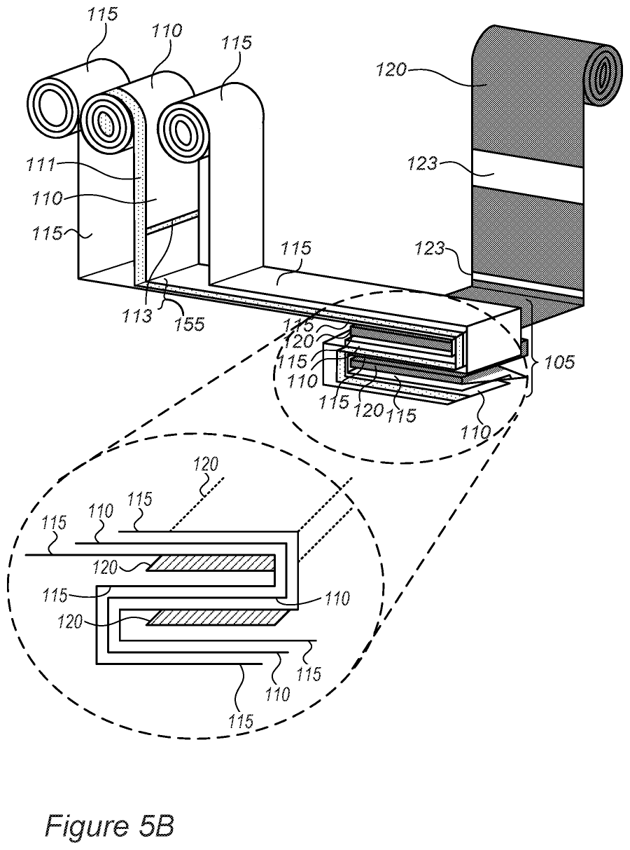

FIGS. 5A and 5B are high level schematic illustrations of Z-folding assembly 107, respectively, according to various embodiments of the invention. Z folding may be used to stack anode(s) 110, lithium-coated separator(s) 115 and cathode(s) 120 into cell stack 105. Prelithiation and/or lithiation may be carried out on one or two sides of the respective electrode (e.g., anode(s) 110, cathode(s) 120 or both); and separator 115 may be pressed upon the respective electrode before or during the Z-folding process, to provide the disclosed prelithiation and/or lithiation of the respective electrode. In various embodiments, anode(s) 110 and cathode(s) 120 may be used as separate sheets, while separator 115 may be used as a roll, as illustrated schematically in FIG. 5A. In certain embodiments, anode(s) 110, cathode(s) 120 and separator 115 may be used as rolls that are folded and stacked together (with intermitting gaps 113, 123 separating individual anode and cathode sections, respectively), as illustrated schematically in FIG. 5B.

In various embodiments, lithium from lithium coating 130 may be released during cell assembly and/or during cell formation, e.g., lithium may be transferred from separator 115 to anode(s) 110 and/or to cathode(s) 120 during their attachment, possibly continuously, prior to cell assembly. Alternatively, or complementarily, lithium may be transferred from separator 115 to anode(s) 110 and/or to cathode(s) 120 during or after cell assembly, possibly in the presence of electrolyte 103 that may dissolve at least parts of protective layer 140. Alternatively, or complementarily, lithium may be transferred from separator 115 to anode(s) 110 and/or to cathode(s) 120 during a cell formation stage, with electrochemical processes contributing to the dissolution of at least parts of protective layer 140 and/or to lithium transfer. In certain embodiments, the amount of lithium in lithium coating 130 may correspond to the amount required for the corresponding lithiation (prelithiation of anode(s) 110 and/or lithiation of cathode(s) 120)—to optimize battery operation. In certain embodiments, the amount of lithium in lithium coating 130 may be larger, and excessive lithium and/or lithium residues may be removed following lithiation, e.g., by replacing electrolyte 103 following battery assembly and/or formation, and before battery operation.

Elements from FIGS. 1A through 5B may be combined in any operable combination, and the illustration of certain elements in certain figures and not in others merely serves an explanatory purpose and is non-limiting.

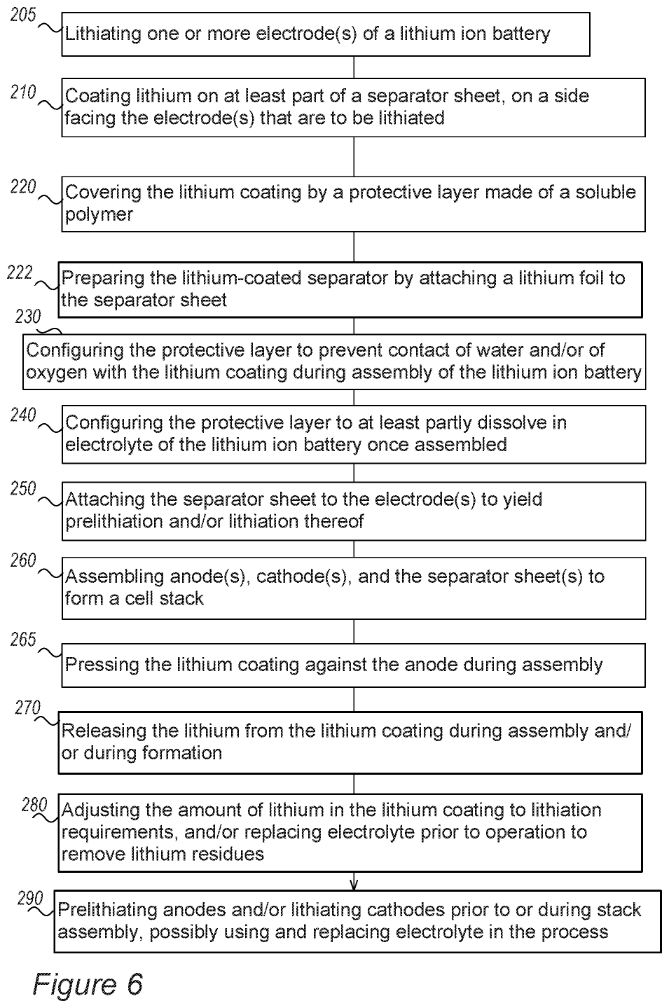

FIG. 6 is a high-level flowchart illustrating a method 200, according to some embodiments of the invention. The method stages may be carried out with respect to separators 115, cell stacks 105, lithium ion batteries 101 and/or assembly systems 107 described above, which may optionally be configured to implement any of the stage of method 200. Method 200 may comprise any of the following stages, irrespective of their order.

Method 200 may comprise lithiating at least one electrode (e.g., one or more anodes, one or more cathodes) of a lithium ion battery (stage 205), by coating lithium on at least part of a separator sheet, on a side facing the at least one electrode that is to be lithiated (stage 210), and attaching the separator sheet to the at least one electrode (stage 250), to yield prelithiation and/or lithiation thereof. Method 200 may further comprise covering the lithium coating by a protective layer made of a soluble polymer (stage 220). Method 200 may further comprise configuring the protective layer to prevent contact of water and/or of oxygen with the lithium coating during assembly of the lithium ion battery (stage 230), and to at least partly dissolve in electrolyte of the lithium ion battery once assembled (stage 240). In certain embodiments, method 200 comprises preparing the lithium-coated separator by attaching a lithium foil to the separator sheet (stage 222), as disclosed above.

Method 200 may further comprise assembling at least one anode, at least one cathode, and at least one of the separator sheets to form a cell stack (stage 260). For example, by any assembling process, such as roll to roll processes. single sheet stacking, winding processes and/or folding processes, wherein method 200 may further comprise pressing the lithium coating against the at least one anode during assembly (stage 265).

In certain embodiments, method 200 further comprises releasing the lithium from the lithium coating during assembly and/or during formation (stage 270). For example, lithium may be transferred from the separator to anode(s) and/or to cathode(s) during their attachment, possibly continuously, prior to cell assembly. Alternatively, or complementarily, lithium may be transferred from the separator to anode(s) and/or to cathode(s) during or after cell assembly, possibly in the presence of the electrolyte that may dissolve at least parts of the protective layer. Alternatively, or complementarily, lithium may be transferred from the separator to anode(s) and/or to cathode(s) during a cell formation stage, with electrochemical processes contributing to the dissolution of at least parts of the protective layer and/or to lithium transfer.

In certain embodiments, method 200 further comprises adjusting the amount of lithium in the lithium coating to lithiation requirements, and/or replacing electrolyte prior to operation to remove lithium residues (stage 280). For example, the amount of lithium in the lithium coating may be the amount required for prelithiation of anode(s) and/or lithiation of cathode(s) that optimizes battery operation. Alternatively, the amount of lithium in the lithium coating may be larger than the amount required for prelithiation of anode(s) and/or lithiation of cathode(s) that optimizes battery operation—and excessive lithium and/or lithium residues may be removed following lithiation, e.g., by replacing the electrolyte following battery assembly and/or formation, and before battery operation.

In certain embodiments, method 200 comprises prelithiating anodes and/or lithiating cathodes prior to or during stack assembly, possibly using and replacing electrolyte in the process (stage 290)—to implement “out of cell” anode prelithiation and/or cathode lithiation—before or during the assembly of the cell stack and not only upon formation of the battery. For example, the lithium-coated separator(s) may be pressed to the anodes and/or cathodes before cell assembly, possibly in the presence of temporary electrolyte that may be rinsed and replaced later. The process may be timed and controlled so that the lithiation is completed before the assembly of the cell and the new electrolyte may be filled after cell assembly. With separators having a protective layer upon the lithium coating, the protective layer may be soluble in the temporary electrolyte, and its residues may be removed upon rinsing the temporary electrolyte. In certain embodiments, the protective layer or parts thereof may be not soluble in the operational electrolyte.

Advantageously, disclosed methods 200, separators 115, cell stacks 105, lithium ion batteries 101 and/or assembly systems 107 may be applied using metalloid-based anodes, having anode active material based on Si, Ge and/or Sn, increasing the lithium capacity of such anodes with respect to the prior art and yield anodes 110 and batteries 101 having high energy density and high power, enabling fast charging, e.g., at maximal rates of 4C, 5C, 10C, 20C or more, several tens of C up to 100C or more. Disclosed prelithiation and lithiation methods include using lithium coating 130 of separators 115 to deliver lithium electrochemically, chemically or physically (by physical attachment) to anode(s) 110 and/or to cathode(s) 120. Disclosed procedures may be incorporated in practiced assembly systems, as demonstrated herein. In particular, disclosed physical attachment of separator 115 and respective electrode(s) (anode(s) 110 and/or cathode(s) 120) may be particularly applicable for integration in current assembly systems and methods, enabling use at a commercial scale to safely and economically incorporate prelithiation and/or lithiation into existing lithium ion battery systems. In certain embodiments, lithium transfer to the respective electrode(s) may be carried out during a formation stage of the battery 101, e.g., electrochemically, and/or during operation of battery 101.

Any of the disclosed embodiments may be implemented in lithium ion batteries to improve their cycle life, charging/discharging rates, safety and/or capacity. Lithium ion batteries typically comprise anodes and cathodes with current collectors affixed thereto, packed with electrolyte and separator(s) in a soft or/and hard package (e.g., pouches, prismatic or cylindrical packages, etc. Disclosed methods, separators and cell stacks may be used with prelithiation methods, formation methods and/or operation methods disclosed in any of U.S. Pat. Nos. 10,297,872, 10,439,254 and 10,122,042, which are incorporated herein by reference in their entirety. Anodes are typically made of anode material particles and additional materials, such as conductive additive(s), binder(s), surfactants, dispersive materials, porosity control materials, etc., and may comprise any of the anode configurations taught, e.g., by U.S. Patent Publication No. 2017/0294687, incorporated herein by reference in its entirety. In certain embodiments, polymerization of the anode coating and/or of coatings of the anode material particles may be controlled, as disclosed, e.g., in any of U.S. Patent Publication No. 2019/0198912 and U.S. Patent Application Nos. 62/711,639 and 62/804,778, incorporated herein by reference in their entirety. For example, anodes may be based on carbon (e.g., graphite, graphene or other carbon-based materials), metalloid anode material such as Si, Ge, Sn and their combinations and/or metals such as Li-metal. Cathodes may comprise lithium metal oxide (LiMeO), wherein Me can be one or several metals selected from Ni, Co, Fe, Mn and Al or sulfur-based cathodes. For example, cathodes may comprise materials based on layered, spinel and/or olivine frameworks, such as LCO formulations (based on LiCoO₂), NMC formulations (based on lithium nickel-manganese-cobalt), NCA formulations (based on lithium nickel cobalt aluminum oxides), LMO formulations (based on LiMn₂O₄), LMN formulations (based on lithium manganese-nickel oxides) lithium iron-phosphorus oxide (LFP) formulations (based on LiFePO₄), lithium rich cathodes, and/or combinations thereof. Cathodes may further comprise additive (e.g., conductive additives), binders, etc. Separator sheets 116 may comprise various materials, e.g., polymers such as any of polyethylene (PE), polypropylene (PP), polyethylene terephthalate (PET), poly vinylidene fluoride (PVDF), polymer membranes such as a polyolefin, polypropylene, or polyethylene membranes. Multi-membranes made of these materials, micro-porous films and/or spray coating thereof, woven or non-woven fabrics etc. may be used as separator sheets 116, as well as possibly composite materials including, e.g., alumina, zirconia, titania, magnesia, silica and calcium carbonate along with various polymer components as listed above.

In various embodiments, the electrolytes may be configured as any of liquid, polymer, gel (e.g., associated with inorganic silica gel electrolytes), glass (e.g., associated with amorphous sulfides-based electrolytes), solid polymer electrolytes (e.g., associated with polyethylene oxide, fluorine-containing polymers and copolymers such as polytetrafluoroethylene), polycrystalline inorganic solid electrolytes and/or combinations thereof. In certain embodiments, solid electrolytes may be used to coat the cathodes. Electrolytes may comprise lithium electrolyte salt(s) such as LiPF₆, LiBF₄, lithium bis(oxalato)borate, LiN(CF₃SO₂)₂, LiN(C₂F₅SO₂)₂, LiA_{S}F₆, LiC(CF₃SO₂)₃, LiClO₄, LiTFSI, LiB(C₂O₄)₂, LiBF₂(C₂O₄)), tris(trimethylsilyl)phosphite (TMSP), and combinations thereof. Ionic liquid(s) may be added to the electrolyte as taught by WIPO Publication No. WO 2018/109774, incorporated herein by reference in its entirety. In certain embodiments, electrolytes may comprise linear solvent comprising at least one three-carbon and/or four-carbon chain ester, cyclic carbonate solvent and at least one lithium salt, as disclosed e.g., in U.S. Patent Publication No. 2019/0148774, incorporated herein by reference in its entirety.

Disclosed lithium ion batteries (and/or respective battery cells thereof) may at least partly be configured, e.g., by selection of materials, to enable operation at high charging and/or discharging rates (C-rate), ranging from 3-10 C-rate, 10-100 C-rate or even above 100 C, e.g., 5 C, 10 C, 15 C, 30 C or more. It is noted that the term C-rate is a measure of charging and/or discharging of cell/battery capacity, e.g., with 1 C denoting charging and/or discharging the cell in an hour, and XC (e.g., 5 C, 10 C, 50 C etc.) denoting charging and/or discharging the cell in 1/X of an hour—with respect to a given capacity of the cell.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs. unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A separator for a lithium ion battery, the separator comprising:
a separator sheet, and
a lithium coating on at least part of the separator sheet.

2. The separator of claim 1, wherein the lithium coating is on one side of the separator sheet.

3. The separator of claim 1, wherein the lithium coating comprises a lithium foil attached to the separator sheet.

4. The separator of claim 1, wherein the lithium coating is patterned.

5. An anode for a lithium ion battery, comprising the separator of claim 1 attached to the anode.

6. The separator of claim 1, further comprising a protective layer made of a soluble polymer and covering the lithium coating.

7. The separator of claim 6, wherein the lithium coating and the protective layer are on one side of the separator sheet.

8. The separator of claim 6, wherein the lithium coating is on one side of the separator sheet and the protective layer is on both sides of the separator sheet.

9. The separator of claim 6, wherein the protective layer is configured to prevent contact of water and/or of oxygen with the lithium coating during assembly of the lithium ion battery, and at least partly dissolve in electrolyte of the lithium ion battery once assembled.

10. The separator of claim 6, wherein the soluble polymer comprises at least one of: PMMA (poly(methyl methacrylate)), low molecular weight butyl acrylate, PEG (polyethylene glycol) waxes, poly-VC (poly-(vinylene carbonate)) and PVP (Poly vinyl pyrrolidone).

11. The separator of claim 6, wherein the protective layer comprises at least two protective materials, one applied between the separator sheet and the lithium coating, another one covering the lithium coating.

12. An anode for a lithium ion battery, comprising the separator of claim 6 attached to the anode.

13. A cell stack for a lithium ion battery, the cell stack comprising:
at least one anode,
at least one cathode, and
at least one separator comprising a separator sheet and a lithium coating on at least part of the separator sheet;
wherein the at least one anode, the at least one cathode, and the at least one separator are assembled to form the cell stack.

14. The cell stack of claim 13, wherein the assembly comprises at least one of: a roll to roll process, a single sheet stacking, a winding process and a folding process, and wherein during assembly, the lithium coating is pressed against the at least one anode.

15. The cell stack of claim 13, wherein the at least one separator is attached to the at least one anode or to the at least one cathode prior to the cell stack assembly.

16. The cell stack of claim 15, wherein the at least one anode or to the at least one cathode is lithiated from the at least one separator upon attachment, in presence of a temporary electrolyte, prior to and/or during the cell stack assembly, and wherein the temporary electrolyte is rinsed prior to preparation of the lithium ion battery from the assembled cell stack.

17. The cell stack of claim 16, wherein the at least one separator further comprises a protective layer made of a soluble polymer and covering the lithium coating, and wherein the protective layer is soluble in the temporary electrolyte.

18. The cell stack of claim 13, wherein the at least one separator further comprises a protective layer made of a soluble polymer and covering the lithium coating.

19. The cell stack of claim 18, wherein the protective layer is configured to prevent contact of water and/or of oxygen with the lithium coating during the cell stack assembly, and at least partly dissolve in electrolyte of the lithium ion battery once assembled.

20. The cell stack of claim 18, wherein the soluble polymer comprises at least one of: PMMA (poly(methyl methacrylate)), low molecular weight butyl acrylate, PEG (polyethylene glycol) wax, poly-VC (poly-(vinylene carbonate)) and PVP (Poly vinyl pyrrolidone).

21. A lithium ion battery comprising the cell stack of claim 13, enclosed with electrolyte within a pouch.
